(19) United States
(12) Patent Application Publication
(10) Pub. No.: US 2017/0241002 A1
(43) Pub. Date: Aug. 24, 2017

(54) NON-ORIENTED ELECTRICAL STEEL SHEET HAVING EXCELLENT MAGNETIC PROPERTIES

(71) Applicant: JFE Steel Corporation, Tokyo (JP)

(72) Inventors: Hiroaki Nakajima, Tokyo (JP); Tomoyuki Okubo, Tokyo (JP); Tadashi Nakanishi, Tokyo (JP); Yoshihiko Oda, Tokyo (JP)

(21) Appl. No.: 15/503,508

(22) PCT Filed: Jun. 24, 2015
(86) PCT No.: PCT/JP2015/068123

§ 371 Date: Feb. 13, 2017

(30) Foreign Application Priority Data
Aug. 20, 2014 (JP) 2014-167609

(51) Int. Cl. C22C 38/60; C22C 38/16; C22C 38/10; H01F 1/147; C22C 38/04; C22C 38/02; C22C 38/00; C22C 38/34; C22C 38/06

(52) U.S. Cl. CPC C22C 38/60; C22C 38/34; C22C 38/16; C22C 38/105; C22C 38/06; C22C 38/04; C22C 38/02; C22C 38/008; C22C 38/005; C22C 38/004; C22C 38/002; C22C 38/001; H01F 1/14791

(57) ABSTRACT

A non-oriented electrical steel sheet has excellent magnetic properties and a chemical composition including C: not more than 0.01 mass %, Si: not more than 6 mass %, Mn: 0.05-3 mass %, P: not more than 0.2 mass %, Al: not more than 2 mass % but preferably not more than 0.005 mass %, N: not more than 0.005 mass %, S: not more than 0.01 mass %, Ga: not more than 0.0005 mass % even if hot band annealing is omitted.

### TECHNICAL FIELD

This disclosure relates to a non-oriented electrical steel sheet, and concretely to a non-oriented electrical steel sheet having excellent magnetic properties.

### BACKGROUND

A non-oriented electrical steel sheet is a type of soft magnetic material widely used as an iron core material for rotors and the like. In the recent trend of energy savings, there are increasing demands for efficiency improvement, downsizing and weight reduction of electrical machineries. Hence, it becomes more important to improve magnetic properties of the iron core material.

The non-electrical steel sheet is usually produced by subjecting a raw steel material (slab) containing silicon to hot rolling, hot-band annealing if necessary, cold rolling and finish annealing. To realize excellent magnetic properties, it is required to obtain a texture suitable for the magnetic properties at a stage after the finish annealing. To this end, the hot-band annealing is considered to be essential.

However, addition of the hot band annealing process has a problem that not only the number of days for production becomes long, but also production cost is increased. In particular, an increase in productivity and a decrease in production cost recently start to be considered important in association with an increase of demands for the electrical steel sheet. Hence, techniques of omitting hot band annealing have been actively developed.

As a technique of omitting the hot-band annealing, for example, JP-A-2000-273549 discloses a method of improving magnetic properties by decreasing S content to not more than 0.0015 mass % to improve growth of crystal grains, adding Sb and Sn to suppress nitriding of the surface layer, and winding the sheet at a high temperature during the hot rolling to coarsen the crystal grain size of the hot rolled sheet having an influence on the magnetic flux density.

JP-A-2008-524449 discloses a technique as to a production method of a non-oriented electrical steel sheet wherein an iron loss is decreased and a magnetic flux density is increased without conducting the hot band annealing by controlling alloy-component elements, optimizing hot rolling conditions and using phase transformation of steel to control hot-rolled texture.

In the method disclosed in JP '549, however, it is necessary to reduce S content to an extremely low amount so that the production cost (desulfurization cost) is increased. Also, in the method of JP '449, there are many restrictions on steel ingredients and hot rolling conditions so that there is a problem that the actual production is difficult.

It could therefore be helpful to provide a non-oriented electrical steel sheet having excellent magnetic properties at a low cost even if the hot band annealing is omitted.

### SUMMARY

We investigated the influence of impurities inevitably contained in the raw steel material upon the magnetic properties. We found that magnetic flux density and iron loss property can be significantly increased by particularly decreasing Ga among the inevitable impurities to an extremely low amount or further decreasing Al to an extremely low amount even if hot band annealing is omitted.

We thus provide a non-oriented electrical steel sheet having a chemical composition comprising C: not more than 0.01 mass %, Si: not more than 6 mass %, Mn: 0.05-3 mass %, P: not more than 0.2 mass %, Al: not more than 2 mass %, N: not more than 0.005 mass %, S: not more than 0.01 mass %, Ga: not more than 0.0005 mass %, and the remainder being Fe and inevitable impurities.

The non-oriented electrical steel sheet is characterized in that Al content is not more than 0.005 mass %.

Also, the non-oriented electrical steel sheet is characterized by containing one or two of Sn: 0.01-0.2 mass % and Sb: 0.01-0.2 mass % in addition to the above chemical composition.

Further, the non-oriented electrical steel sheet is characterized by containing one or more selected from Ca: 0.0005-0.03 mass %, REM: 0.0005-0.03 mass % and Mg: 0.0005-0.03 mass % in addition to the above chemical composition.

Furthermore, the non-oriented electrical steel sheet is characterized by containing one or more selected from Ni: 0.01-2.0 mass %, Co: 0.01-2.0 mass %, Cu: 0.03-5.0 mass % and Cr: 0.05-5.0 mass % in addition to the above chemical composition.

The non-oriented electrical steel sheet having excellent magnetic properties can be produced even if hot band annealing is omitted so that it is possible to provide non-oriented electrical steel sheets having excellent magnetic properties at a low cost in a short period of time.

### BRIEF DESCRIPTION OF THE DRAWINGS

FIG. 1 is a graph showing an influence of Ga content upon a magnetic flux density B₅₀.

FIG. 2 is a graph showing an influence of Al content upon a magnetic flux density B₅₀.

### DETAILED DESCRIPTION

First, experiments on the development of our steel sheet will be described.

### Experiment 1

We investigated the influence of Ga content as an inevitable impurity upon the magnetic flux density to develop a non-oriented electrical steel sheet having excellent magnetic properties even if hot-band annealing is omitted.

Steels prepared by variously changing an addition amount of Ga within a range of tr. 0.002 mass % in a chemical composition system comprising C: 0.0025 mass %, Si: 3.0 mass %, Mn: 0.25 mass %, P: 0.01 mass %, N: 0.002 mass %, S: 0.002 mass % and Al: two levels of 0.2 mass % and 0.002 mass % are melted and cast in a laboratorial way to form steel ingots, which are hot rolled to form hot rolled sheets of 3.0 mm in thickness and subjected to a heat treatment corresponding to a coiling temperature of 750° C. Thereafter, the hot rolled sheets are pickled without conducting hot band annealing and cold rolled to form cold rolled sheets having a thickness of 0.50 mm, which are subjected to a finish annealing at 1000° C. for 10 seconds under an atmosphere of 20 vol % H₂-80 vol % N₂.

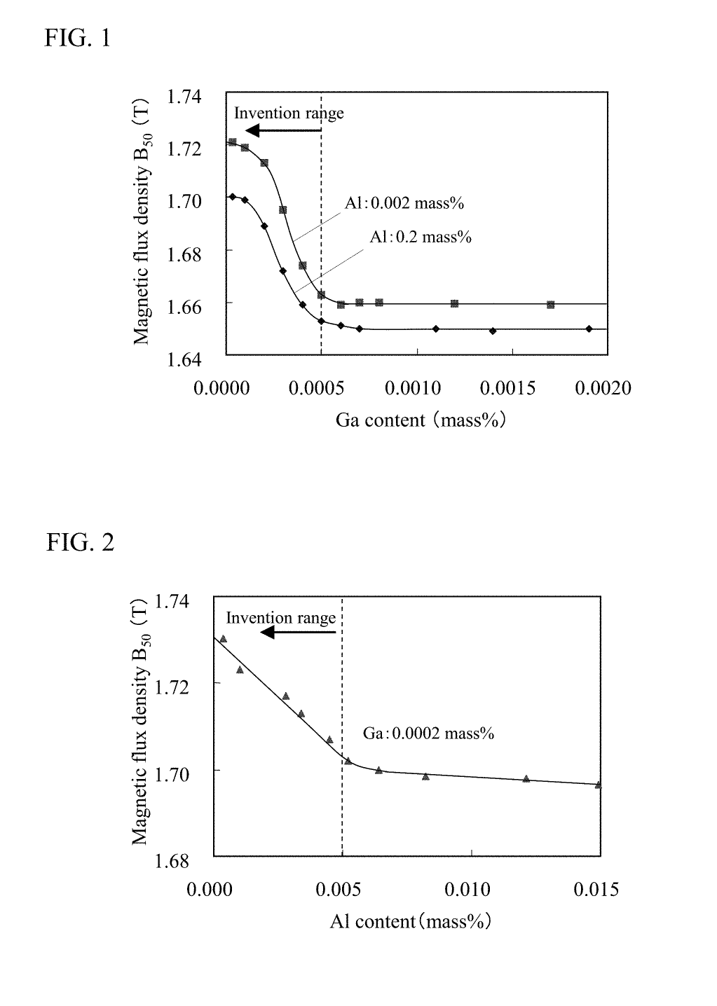

Magnetic flux densities B₅₀ of the thus obtained steel sheets after the finish annealing are measured by a 25 cm Epstein method to obtain the results shown in FIG. 1.

It can be seen that the magnetic flux density B₅₀ is rapidly increased when the Ga content is not more than 0.0005 mass %, and the effect of increasing the magnetic flux density due to the decrease of Ga content is larger when Al content is 0.002 mass % than 0.2 mass %.

### Experiment 2

We conducted an experiment to investigate the influence of Al content upon the magnetic flux density.

Steels prepared by variously changing an addition amount of Al within a range of tr.-0.01 mass % in a chemical composition system comprising C: 0.0025 mass %, Si: 3.0 mass %, Mn: 0.25 mass %, P: 0.01 mass %, N: 0.002 mass %, S: 0.002 mass % and Ga decreased to 0.0002 mass % are melted in a laboratorial way and magnetic flux densities B₅₀ of the steel sheets after the finish annealing in the same way as in Experiment 1 are measured by a 25 cm Epstein method.

FIG. 2 shows the relationship between Al content and magnetic flux density B₅₀ with respect to the above measured results. As seen from FIG. 2, the magnetic flux density is increased when Al content is not more than 0.005 mass %.

As seen from the above experimental results, the magnetic flux density can be significantly increased by decreasing Ga content to not more than 0.0005 mass % or further by decreasing Ga content to not more than 0.0005 mass % while decreasing Al content to not more than 0.005 mass %.

The reason why the magnetic flux density is significantly increased by the decreases of Ga content and Al content is not entirely clear, but we believe that the recrystallization temperature of the raw material is lowered by decreasing Ga to change recrystallization behavior in the hot rolling to thereby improve the texture of the hot rolled sheet. Particularly, the reason why the magnetic flux density is considerably increased when Al content is not more than 0.005 mass % is believed to be due to the fact that mobility of grain boundary is changed by the decrease of Ga and Al to promote growth of crystal orientation advantageous for the magnetic properties.

Next, there will be explained the chemical composition of the non-oriented electrical steel sheet.

C: Not More than 0.01 Mass %

C causes magnetic aging in a product sheet so that it is limited to not more than 0.01 mass %. Preferably, it is not more than 0.005 mass %.

Si: Not More than 6 Mass %

Si is an element effective to increase specific resistance of steel and decrease iron loss so that it is preferable to be contained in an amount of not less than 1 mass %. When it is added in an amount exceeding 6 mass %, however, it is difficult to perform cold rolling because considerable embrittlement is caused so that the upper limit is 6 mass %. Preferably, it is 1-4 mass %, and more preferably 1.5-3 mass %.

### Mn: 0.05-3 Mass %

Mn is an element effective to prevent red brittleness in the hot rolling and, therefore, it is required to be contained in an amount of not less than 0.05 mass %. When it exceeds 3 mass %, however, the cold rolling property is deteriorated or a decrease in the magnetic flux density is caused so that the upper limit is 3 mass %. Preferably, it is 0.05-1.5 mass %. More preferably, it is 0.2-1.3 mass %.

P: Not More than 0.2 Mass %

P can be added because it is excellent in the solid-solution strengthening ability and is an element effective in adjusting hardness to improve punchability of steel. However, when the amount exceeds 0.2 mass %, embrittlement becomes remarkable so that the upper limit is set to 0.2 mass %. Preferably, it is not more than 0.15 mass %, more preferably not more than 0.1 mass %.

S: Not More than 0.01 Mass %

S is a harmful element forming sulfide such as MnS or the like to increase iron loss so that the upper limit is 0.01 mass %. Preferably, it is not more than 0.005 mass %, and more preferably not more than 0.003 mass %.

Al: Not More than 2 Mass %

Al can be added because it is an element effective in increasing specific resistance of steel and decreasing an eddy current loss. However, when it exceeds 2.0 mass %, the cold rolling property is deteriorated so that the upper limit is 2.0 mass %.

To better receive the effect of improving the magnetic properties by the decrease of Ga, it is preferable to be decreased to not more than 0.005 mass %. More preferably, it is not more than 0.001 mass %.

N: Not More than 0.005 Mass %

N is a harmful element forming nitride to increase iron loss so that the upper limit is 0.005 mass %. Preferably, it is not more than 0.003 mass %.

Ga: Not More than 0.0005 Mass %

Ga is the most important element because it has a substantial bad influence on a texture of a hot rolled sheet even in a slight amount. To suppress the bad influence, it is necessary to be not more than 0.0005 mass %. Preferably, it is not more than 0.0001 mass %.

The non-oriented electrical steel sheet may contain one or two of Sn and Sb in ranges of Sb: 0.01-0.2 mass % and Sn: 0.01-0.2 mass % in addition to the above ingredients to improve magnetic properties.

Sb and Sn improve the texture of a product sheet and are elements effective in increasing magnetic flux density. The above effect is obtained in an addition amount of not less than 0.01 mass %. On the other hand, when it exceeds 0.2 mass %, the above effect is saturated. Therefore, when adding the elements, each element is preferably 0.01-0.2 mass %. More preferably, it is Sb: 0.02-0.15 mass % and Sn: 0.02-0.15 mass %.

The non-oriented electrical steel sheet may further contain one or more selected from Ca, REM and Mg as follows: Ca: 0.0005-0.03 mass %, REM: 0.0005-0.03 mass % and Mg: 0.0005-0.03 mass % in addition to the above ingredients.

Each of Ca, REM and Mg fixes S to suppress fine precipitation of sulfide and is an element effective in decreasing iron loss. To obtain such an effect, each element is required to be added in an amount of not less than 0.0005 mass %. However, when it is added in an amount exceeding 0.03 mass %, the effect is saturated. Therefore, when adding Ca, REM and Mg, each element is preferably 0.0005-0.03 mass %. More preferably, it is 0.001-0.01 mass %.

The non-oriented electrical steel sheet may further contain one or more selected from Ni, Co, Cu and Cr as follows: Ni: 0.01-2.0 mass %, Co: 0.01-2.0 mass %, Cu: 0.03-5.0 mass % and Cr: 0.05-5.0 mass % in addition to the above ingredients.

Ni, Co, Cu and Cr are elements effective in decreasing iron loss because each element increases the specific resistance of steel. To obtain such an effect, it is preferable to add Ni and Co in an amount of not less than 0.01 mass % for each, Cu in an amount of not less than 0.03 mass % and Cr in an amount of not less than 0.05 mass %. However, when Ni and Co are added in an amount exceeding 2.0 mass % and Cu and Cr are added in an amount exceeding 5.0 mass %, alloy cost is increased. Therefore, when adding Ni and Co, the amount of each is 0.01-2.0 mass % and, when adding Cu, the amount is 0.03-5.0 mass % and, when adding Cr, the amount is 0.05-5.0 mass %. More preferably, it is Ni: 0.03-1.5 mass %, Co: 0.03-1.5 mass %, Cu: 0.05-3.0 mass % and Cr: 0.1-3.0 mass %.

The remainder other than the above ingredients in the non-oriented electrical steel sheet is Fe and inevitable impurities. However, the addition of other elements may be accepted within a range not damaging the desired effects.

Next, the method of producing the non-oriented electrical steel sheet will be described below.

The non-oriented electrical steel sheet can be produced by the conventionally well-known production method for the non-oriented electrical steel sheet as long as Ga and Al are contained in the aforementioned ranges as a raw material used in production. For example, it can be produced by a method wherein a steel adjusted to have the predetermined chemical composition in a refining process of melting the steel in a converter, an electric furnace or the like and performing secondary refining in a vacuum degassing apparatus or the like is subjected to an ingot making-blooming method or continuous casting to form a raw steel material (slab), which is then subjected to hot rolling, pickling, cold rolling, finish annealing, and an application and baking of an insulation coating.

In the production method of the non-oriented electrical steel sheet, excellent magnetic properties can be obtained even if hot band annealing after hot rolling is omitted. However, hot band annealing may be conducted and, at this time, the soaking temperature is preferably 900-1200° C. When the soaking temperature is lower than 900° C., the effect caused by the hot band annealing cannot be sufficiently obtained. Hence, the effect of further improving the magnetic properties cannot be obtained. On the other hand, when it exceeds 1200° C., the grain size of the hot rolled sheet is coarsened too much, and there is a possibility of causing cracks or fractures during the cold rolling and it becomes disadvantageous costwise.

Also, the cold rolling from the hot rolled sheet to the cold rolled sheet with a product sheet thickness (final thickness) may be conducted once or twice or more interposing an intermediate annealing therebetween. In particular, the final cold rolling to the final thickness is preferably warm rolling performed at a sheet temperature raised to approximately 200° C. because it has a large effect of increasing the magnetic flux density as long as there is no problem in equipment, production constraint or cost.

The finish annealing applied to the cold rolled sheet with a final thickness is preferably continuous annealing performed by soaking at a temperature of 900-1150° C. for 5-60 seconds. When the soaking temperature is lower than 900° C., the recrystallization is not sufficiently promoted and good magnetic properties are not obtained. While when it exceeds 1150° C., crystal grains are coarsened and iron loss at a high frequency zone is particularly increased.

The steel sheet after finish annealing is preferably coated on its surface with an insulation coating to increase interlayer resistance to decrease iron loss. It is particularly desirable to apply a semi-organic insulation coating containing a resin to ensure good punchability.

The non-oriented electrical steel sheet coated with the insulation coating may be used after being subjected to stress relief annealing by users, or may be used without the stress relief annealing. Also, stress relief annealing may be performed after a punching process is conducted by users. The stress relief annealing is usually performed under a condition of about 750° C. for 2 hours.

### Example

Steels No. 1-31 having a chemical composition shown in Table 1 are melted in a refining process of convertor-vacuum degassing treatment and continuously cast to form steel slabs, which are heated at a temperature of 1140° C. for 1 hour and hot rolled at a finish hot rolling temperature of 900° C. to form hot rolled sheets having a sheet thickness of 3.0 mm, and wound around a coil at a temperature of 750° C. Next, the coil is pickled without being subjected to hot band annealing, and cold rolled once to provide a cold rolled sheet having a sheet thickness of 0.5 mm, which is subjected to finish annealing under soaking conditions of 1000° C. and 10 seconds to provide a non-oriented electrical steel sheet.

From the thus obtained steel sheet are taken out Epstein test specimens of 30 mm×280 mm to measure iron loss W_{15/50} and magnetic flux density B₅₀ by a 25 cm Epstein apparatus, the results of which are also shown in Table 1.

As seen from Table 1, non-oriented electrical steel sheets having excellent magnetic properties can be obtained by controlling a chemical composition of a raw steel material to our ranges even if hot band annealing is omitted.

TABLE 1

| | Chemical composition (mass %) | | | | | | | | | | Magnetic properties | | |
|---|---|---|---|---|---|---|---|---|---|---|---|---|---|
| | | | | | | | | | Sn, Sb, Ca, | Ni, Co, | Iron loss | Magnetic flux | |
| No. | C | P | Si | Mn | Al | N | S | Ga | REM, Mg | Cu, Cr | W_{15/50} (W/kg) | density B₅₀(T) | Remarks |
| 1 | 0.0029 | 0.01 | 3.02 | 0.255 | 0.19 | 0.0019 | 0.0019 | 0.0001 | tr. | tr. | 2.75 | 1.701 | Example |
| 2 | 0.0024 | 0.02 | 2.97 | 0.210 | 0.20 | 0.0020 | 0.0018 | 0.0003 | tr. | tr. | 2.96 | 1.673 | Example |
| 3 | 0.0028 | 0.01 | 3.00 | 0.248 | 0.006 | 0.0022 | 0.0022 | 0.0001 | tr. | tr. | 2.79 | 1.706 | Example |
| 4 | 0.0025 | 0.02 | 2.99 | 0.251 | 0.003 | 0.0020 | 0.0023 | 0.0001 | tr. | tr. | 2.72 | 1.718 | Example |
| 5 | 0.0026 | 0.01 | 2.97 | 0.251 | 0.001 | 0.0021 | 0.0021 | 0.0001 | tr. | tr. | 2.64 | 1.731 | Example |
| 6 | 0.0023 | 0.02 | 3.04 | 0.252 | 0.18 | 0.0022 | 0.0019 | 0.0007 | tr. | tr. | 3.23 | 1.651 | Comparative |
| | | | | | | | | | | | | | Example |
| 7 | 0.0024 | 0.01 | 3.03 | 0.251 | 0.001 | 0.0017 | 0.0023 | 0.0006 | tr. | tr. | 3.26 | 1.661 | Comparative |
| | | | | | | | | | | | | | Example |
| 8 | 0.0023 | 0.01 | 1.52 | 0.256 | 0.24 | 0.0021 | 0.0024 | 0.0001 | tr. | tr. | 3.01 | 1.738 | Example |
| 9 | 0.0025 | 0.02 | 1.49 | 0.252 | 0.007 | 0.0019 | 0.0024 | 0.0001 | tr. | tr. | 3.06 | 1.745 | Example |
| 10 | 0.0025 | 0.01 | 1.45 | 0.254 | 0.001 | 0.0018 | 0.0022 | 0.0001 | tr. | tr. | 2.92 | 1.768 | Example |
| 11 | 0.0025 | 0.01 | 1.54 | 0.247 | 0.22 | 0.0018 | 0.0016 | 0.0006 | tr. | tr. | 3.53 | 1.687 | Comparative |
| | | | | | | | | | | | | | Example |
| 12 | 0.0220 | 0.02 | 2.99 | 0.249 | 0.26 | 0.0020 | 0.0019 | 0.0001 | tr. | tr. | 4.04 | 1.651 | Comparative |
| | | | | | | | | | | | | | Example |
| 13 | 0.0028 | 0.22 | 2.98 | 0.252 | 0.19 | 0.0023 | 0.0019 | 0.0001 | tr. | tr. | Cannot be rolled due to | | Comparative |
| | | | | | | | | | | | embrittlement | | Example |
| 14 | 0.0031 | 0.02 | 3.03 | 3.210 | 0.21 | 0.0021 | 0.0021 | 0.0001 | tr. | tr. | Cannot be rolled due to | | Comparative |
| | | | | | | | | | | | embrittlement | | Example |
| 15 | 0.0027 | 0.02 | 3.02 | 0.251 | 2.21 | 0.0023 | 0.0020 | 0.0001 | tr. | tr. | Cannot be rolled due to | | Comparative |
| | | | | | | | | | | | embrittlement | | Example |
| 16 | 0.0028 | 0.03 | 2.94 | 0.255 | 0.21 | 0.0054 | 0.0027 | 0.0001 | tr. | tr. | 3.79 | 1.659 | Comparative |
| | | | | | | | | | | | | | Example |
| 17 | 0.0022 | 0.03 | 3.05 | 0.252 | 0.19 | 0.0016 | 0.0130 | 0.0001 | tr. | tr. | 3.72 | 1.661 | Comparative |
| | | | | | | | | | | | | | Example |
| 18 | 0.0031 | 0.02 | 3.02 | 0.247 | 0.001 | 0.0020 | 0.0021 | 0.0001 | Sn: 0.04 | tr. | 2.58 | 1.745 | Example |
| 19 | 0.0035 | 0.01 | 2.97 | 0.256 | 0.001 | 0.0021 | 0.0026 | 0.0001 | Sb: 0.03 | tr. | 2.59 | 1.743 | Example |
| 20 | 0.0032 | 0.02 | 3.06 | 0.249 | 0.001 | 0.0022 | 0.0030 | 0.0001 | Sn: 0.03, | tr. | 2.53 | 1.756 | Example |
| | | | | | | | | | Sb: 0.03 | | | | |
| 21 | 0.0027 | 0.01 | 3.02 | 0.255 | 0.001 | 0.0024 | 0.0030 | 0.0001 | Sn: 0.04, | tr. | 2.52 | 1.753 | Example |
| | | | | | | | | | a: 0.003 | | | | |
| 22 | 0.0024 | 0.02 | 3.04 | 0.25 | 0.001 | 0.0021 | 0.0025 | 0.0001 | Sn: 0.04, | tr | 2.52 | 1.755 | Example |
| | | | | | | | | | REM: 0.004 | | | | |
| 23 | 0.0023 | 0.02 | 2.94 | 0.245 | 0.001 | 0.0017 | 0.0022 | 0.0001 | Sn: 0.03 | tr. | 2.51 | 1.754 | Example |
| | | | | | | | | | Mg: 0.005 | | | | |
| 24 | 0.0028 | 0.02 | 2.99 | 0.247 | 0.001 | 0.0019 | 0.0018 | 0.0001 | tr. | Ni: 0.03 | 2.55 | 1.729 | Example |
| 25 | 0.0034 | 0.02 | 2.98 | 0.245 | 0.001 | 0.0023 | 0.0018 | 0.0001 | tr. | Ni: 1.48 | 2.31 | 1.731 | Example |
| 26 | 0.0030 | 0.01 | 3.03 | 0.251 | 0.001 | 0.0019 | 0.0023 | 0.0001 | tr. | Co: 0.03 | 2.56 | 1.730 | Example |
| 27 | 0.0027 | 0.01 | 3.02 | 0.252 | 0.001 | 0.0024 | 0.0021 | 0.0001 | tr. | Co: 1.51 | 2.30 | 1.729 | Example |
| 28 | 0.0023 | 0.01 | 3.03 | 0.252 | 0.001 | 0.0025 | 0.0021 | 0.0001 | tr. | Cu: 0.05 | 2.53 | 1.730 | Example |
| 29 | 0.0026 | 0.02 | 3.00 | 2.540 | 0.001 | 0.0025 | 0.0022 | 0.0001 | tr. | Cu: 1.55 | 2.31 | 1.731 | Example |
| 30 | 0.0026 | 0.02 | 3.04 | 0.250 | 0.001 | 0.0021 | 0.0019 | 0.0001 | tr. | Cr: 0.11 | 2.53 | 1.730 | Example |
| 31 | 0.0033 | 0.02 | 2.99 | 0.252 | 0.001 | 0.0021 | 0.0023 | 0.0001 | tr. | Cr: 1.52 | 2.29 | 1.730 | Example |

1-5. (canceled)

6. A non-oriented electrical steel sheet having a chemical composition comprising C: not more than 0.01 mass %, Si: not more than 6 mass %, Mn: 0.05-3 mass %, P: not more than 0.2 mass %, Al: not more than 2 mass %, N: not more than 0.005 mass %, S: not more than 0.01 mass %, Ga: not more than 0.0005 mass % and the remainder being Fe and inevitable impurities.

7. The non-oriented electrical steel sheet according to claim 6, wherein Al content is not more than 0.005 mass %.

8. The non-oriented electrical steel sheet according to claim 6, further comprising one or two of Sn: 0.01-0.2 mass % and Sb: 0.01-0.2 mass % in addition to the above chemical composition.

9. The non-oriented electrical steel sheet according to claim 7, further comprising one or two of Sn: 0.01-0.2 mass % and Sb: 0.01-0.2 mass % in addition to the above chemical composition.

10. The non-oriented electrical steel sheet according to claim 6, further comprising one or more selected from Ca: 0.0005-0.03 mass %, REM: 0.0005-0.03 mass % and Mg: 0.0005-0.03 mass % in the chemical composition.

11. The non-oriented electrical steel sheet according to claim 7, further comprising one or more selected from Ca: 0.0005-0.03 mass %, REM: 0.0005-0.03 mass % and Mg: 0.0005-0.03 mass % in the chemical composition.

12. The non-oriented electrical steel sheet according to claim 8, further comprising one or more selected from Ca: 0.0005-0.03 mass %, REM: 0.0005-0.03 mass % and Mg: 0.0005-0.03 mass % in the chemical composition.

13. The non-oriented electrical steel sheet according to claim 9, further comprising one or more selected from Ca: 0.0005-0.03 mass %, REM: 0.0005-0.03 mass % and Mg: 0.0005-0.03 mass % in the chemical composition.

14. The non-oriented electrical steel sheet according to claim 6, further comprising one or more selected from Ni: 0.01-2.0 mass %, Co: 0.01-2.0 mass %, Cu: 0.03-5.0 mass % and Cr: 0.05-5.0 mass % in the chemical composition.

15. The non-oriented electrical steel sheet according to claim 7, further comprising one or more selected from Ni: 0.01-2.0 mass %, Co: 0.01-2.0 mass %, Cu: 0.03-5.0 mass % and Cr: 0.05-5.0 mass % in the chemical composition.

16. The non-oriented electrical steel sheet according to claim 8, further comprising one or more selected from Ni: 0.01-2.0 mass %, Co: 0.01-2.0 mass %, Cu: 0.03-5.0 mass % and Cr: 0.05-5.0 mass % in the chemical composition.

17. The non-oriented electrical steel sheet according to claim 9, further comprising one or more selected from Ni: 0.01-2.0 mass %, Co: 0.01-2.0 mass %, Cu: 0.03-5.0 mass % and Cr: 0.05-5.0 mass % in the chemical composition.

18. The non-oriented electrical steel sheet according to claim 10, further comprising one or more selected from Ni: 0.01-2.0 mass %, Co: 0.01-2.0 mass %, Cu: 0.03-5.0 mass % and Cr: 0.05-5.0 mass % in the chemical composition.

19. The non-oriented electrical steel sheet according to claim 11, further comprising one or more selected from Ni: 0.01-2.0 mass %, Co: 0.01-2.0 mass %, Cu: 0.03-5.0 mass % and Cr: 0.05-5.0 mass % in the chemical composition.

20. The non-oriented electrical steel sheet according to claim 12, further comprising one or more selected from Ni: 0.01-2.0 mass %, Co: 0.01-2.0 mass %, Cu: 0.03-5.0 mass % and Cr: 0.05-5.0 mass % in the chemical composition.

21. The non-oriented electrical steel sheet according to claim 13, further comprising one or more selected from Ni: 0.01-2.0 mass %, Co: 0.01-2.0 mass %, Cu: 0.03-5.0 mass % and Cr: 0.05-5.0 mass % in the chemical composition.
